(19) United States
(12) Patent Application Publication
(10) Pub. No.: US 2008/0310309 A1
(43) Pub. Date: Dec. 18, 2008

(54) SENDING CONTENT FROM MULTIPLE QUEUES TO CLIENTS

(76) Inventors: Glenn Darrell Batalden, Rochester, MN (US); Timothy Pressler Clark, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/762,429

(22) Filed: Jun. 13, 2007

(51) Int. Cl. H04L 12/56

(52) U.S. Cl. 370/236

(57) ABSTRACT

In an embodiment, a content server has multiple queues, each of which includes records. Each record in a queue represents a frame in a logical group of frames. Each of the queues transitions between a control state, an ingestion state, and a distribution state. During the control states, records are added to the queues. During the ingestion states, the frames are copied into memory at the content server. During the distribution states, the content server sends the logical groups to a client. Each of the control state, the ingestion state, and the distribution state has a time duration equal to the amount of time needed to play the logical group.

### CROSS-REFERENCE TO RELATED APPLICATIONS

The present application is related to commonly-assigned patent application Ser. No. ______, Attorney Docket Number ROC920060366US 1, to Glenn D. Batalden, et al., filed on even date herewith, entitled “SENDING CONTENT FROM MULTIPLE CONTENT SERVERS TO CLIENTS AT TIME REFERENCE POINTS,” which is herein incorporated by reference. The present application is also related to commonly-assigned patent application Ser. No. ______, Attorney Docket Number ROC920060485US1, to Glenn D. Batalden, et al., filed on even date herewith, entitled “DETERMINING A TRANSMISSION ORDER FOR FRAMES BASED ON BIT REVERSALS OF SEQUENCE NUMBERS,” which is herein incorporated by reference.

### FIELD

An embodiment of the invention generally relates to sending video content from multiple queues at a server to client devices.

### BACKGROUND

Years ago, computers were isolated devices that did not communicate with each other. But, computers are increasingly being connected together in networks. One use of this connectivity is for the real-time and near real-time audio and video transmission over networks, such as networks that use the Internet Protocol (IP) and provide video-on-demand. One of the challenges facing IPTV (Internet Protocol Television) implementations and video-on-demand is the difficulty of scheduling computational and network bandwidth and avoiding video “stuttering” that occurs as a delivery network approaches saturation. Traditional methods of broadcast delivery in an IP network use a technique known as “pull technology” where the client (e.g., a set-top box, personal computer, web browser, or television set) requests the video content asynchronously, which results in latency that varies geometrically with utilization. Latency is generally represented as L=1/(1−M), where L is the latency factor and M is the utilization as a percentage of available bandwidth. As a result, e.g., data packets traveling in a network that is using 50% of its bandwidth take nearly twice as long to arrive as those in a 1% utilized network. Occasional latency and jitter may be acceptable in traditional IP applications (e.g., web browsing or file transfer), but a more reliable delivery method is required for transmitting real-time data such as on-demand video.

Another challenge facing video-on-demand and IPTV (Internet Protocol Television) implementations is that the introduction of a video content load into a network provides high spikes of network utilization. When networks are driven into periodic high (e.g., 90-100 percent) utilization, the chances for network congestion, errors, packet loss, and overloading increases significantly.

Currently, traffic shaping is the primary means to alleviate the effects of high network use and enable greater utilization of network resources. But, current traffic shaping algorithms (e.g., leaky bucket or token bucket) do their work after data has already entered the network. As a result, current traffic shaping algorithms may drop data (if too much data is entering a network link), requiring retransmission, and they may introduce latency (via queuing delays). These effects introduce stutter into the stream received by the client device of the customer. To eliminate stuttering, client devices often buffer the data stream until enough data has been received to reliably cover up any subsequent interruptions in the stream. But, buffering introduces a noticeable delay when changing between streams, which may be acceptable when browsing the internet for video clips, but the typical television viewer expects to be able to flip through many channels with little or no delay. To compete with cable television delivery, Internet television implementations must provide clear, uninterrupted transmission and must permit very fast channel changing, which is not provided by current technology.

Thus, what is needed is an enhanced technique for the delivery of audio/video data in a network.

### SUMMARY

A method, apparatus, system, and storage medium are provided. In an embodiment, a content server has multiple queues, each of which includes records. Each record in a queue represents a frame in a logical group. Each of the queues transitions between a control state, an ingestion state, and a distribution state. During the control states, records are added to the queues. During the ingestion states, the frames are copied into memory at the content server. During the distribution states, the content server sends the logical groups to a client. Each of the control state, the ingestion state, and the distribution state has a time duration equal to the amount of time needed to play the logical group.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a high-level block diagram of selected components of the example system, according to an embodiment of the invention.

FIG. 3 depicts a block diagram of example programs, according to an embodiment of the invention.

FIG. 4 depicts a block diagram of an example queue, which is in a control state, according to an embodiment of the invention.

FIG. 5 depicts a block diagram of an example queue, which is in an ingestion state, according to an embodiment of the invention.

FIG. 6 depicts a block diagram of an example queue, which is in a distribution state, according to an embodiment of the invention.

FIG. 7 depicts a block diagram of the states and state transitions of the queue, according to an embodiment of the invention.

FIG. 8 depicts a block diagram of a timeline of states of multiple queues, according to an embodiment of the invention.

FIG. 9 depicts a flowchart of example processing for handling commands from clients, according to an embodiment of the invention.

FIG. 10 depicts a flowchart of example processing for the control state of a queue, according to an embodiment of the invention.

FIG. 11 depicts a flowchart of example processing for the ingestion state of a queue, according to an embodiment of the invention.

FIG. 12 depicts a flowchart of example processing for the distribution state of a queue, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

In an embodiment, a content server has multiple queues, each of which includes records. Each record in a queue represents a frame in a logical group. Each of the queues transitions between a control state, an ingestion state, and a distribution state. During the control state, records are added to the queue, and commands received from target clients are processed. During the ingestion state, the content of the frames is copied (e.g., from local storage, remote storage, or from a computer system attached to a network) into memory at the content server. During the distribution state, the content server sends the respective logical groups to their respective target clients via the network. Each of the control state, the ingestion state, and the distribution state has a time period, or duration, equal to the amount of time needed to play the logical group at the client. In this way, an embodiment of the invention transmits the frame content in units of logical groups, which eliminates the need for complex session handling between the target clients and the content server. Further, the transmission of logical groups of frames within the time periods provides predictable network bandwidth consumption, such that an embodiment of the invention drives the network load higher than does conventional asynchronous network traffic.

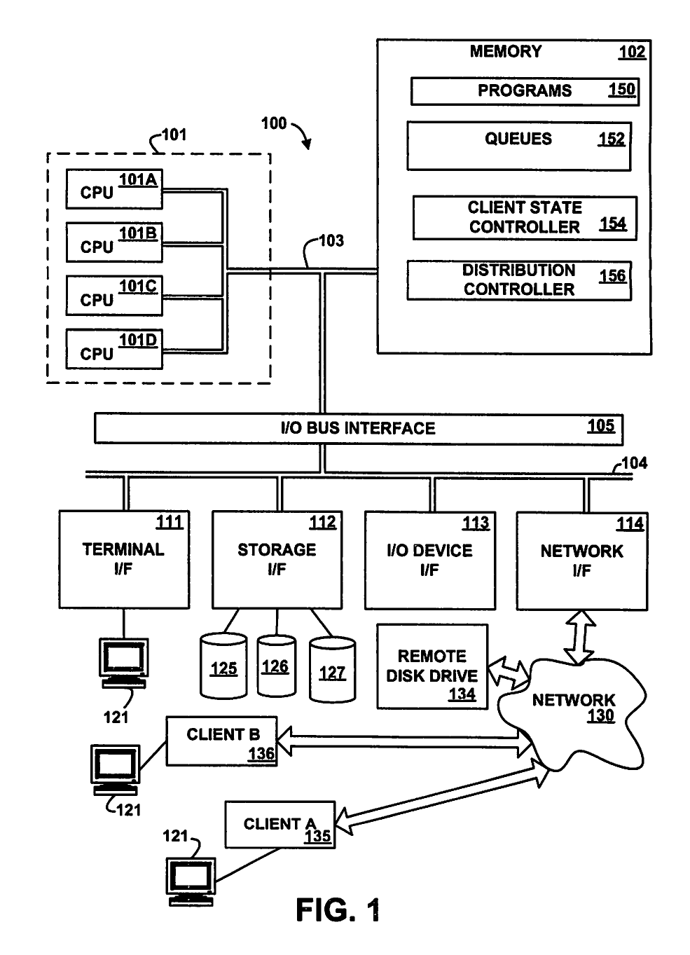

Referring to the Drawings, wherein like numbers denote like parts throughout the several views, FIG. 1 depicts a high-level block diagram representation of a content server computer system 100 connected to a remote disk drive 134 and client computer systems 135 and 136 via a network 130, according to an embodiment of the present invention. The terms “client” and “server” are used herein for convenience only, and in various embodiments a computer system that operates as a client in one environment may operate as a server in another environment, and vice versa. In an embodiment, the hardware components of the computer systems 100, 135, and 136 may be implemented by IBM System i5 computer systems available from International Business Machines Corporation of Armonk, N.Y. But, those skilled in the art will appreciate that the mechanisms and apparatus of embodiments of the present invention apply equally to any appropriate computing system.

The major components of the content server computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing or encoding data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory 102 stores or encodes programs 150, queues 152, a client state controller 154, and a distribution controller 156. Although the programs 150, the queues 152, the client state controller 154, and the distribution controller 156 are illustrated as being contained within the memory 102 in the computer system 100, in other embodiments some or all of them may be on different computer systems and may be accessed remotely, e.g., via the network 130. The computer system 100 may use virtual addressing mechanisms that allow the computer programs of the computer system 100 to behave as if they only have access to a large, single storage entity instead of access to multiple, smaller storage entities. Thus, while the programs 150, the queues 152, the client state controller 154, and the distribution controller 156 are illustrated as being contained within the main memory 102, these elements are not necessarily all completely contained in the same storage device at the same time. Further, although the programs 150, the queues 152, the client state controller 154, and the distribution controller 156 are illustrated as being separate entities, in other embodiments some of them, portions of some of them, or all of them may be packaged together.

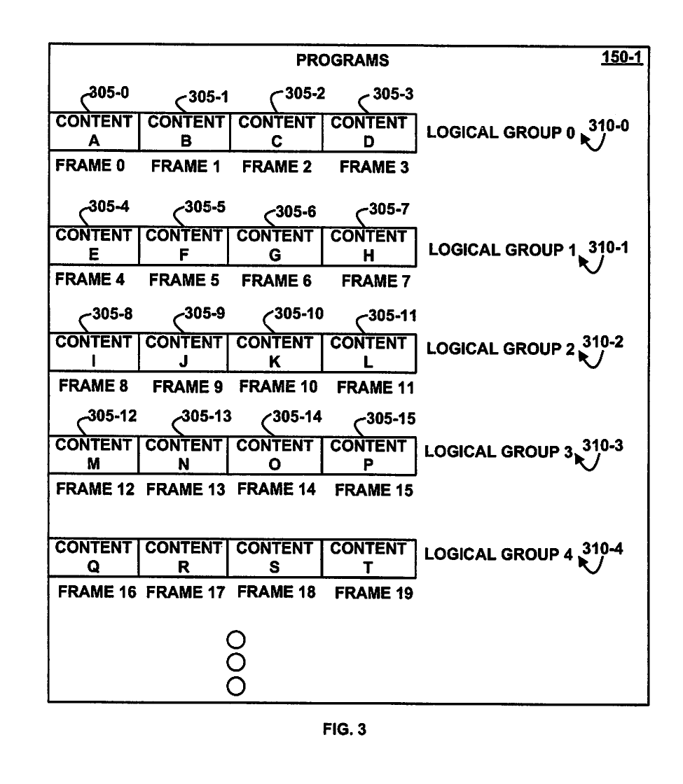

The programs 150 may include frames of video, audio, images, data, control data, formatting data, or any multiple or combination thereof, capable of being played or displayed via the user I/O devices 121. The programs 150 are further described below with reference to FIG. 3. The clients 135 and 136 request one or more of the programs 150. The client state controller 154 receives the request from the clients 135 and 136 and sends commands to the distribution controller 156. The distribution controller 156 assembles and organizes the frames of the programs 150 into logical groups using the queues 152 and then transfers the logical groups identified by the queues 152 to the clients 135 and 136 via the network 130. Multiple instances or threads of the distribution controller 156 exist, one for each queue, which may execute simultaneously or concurrently.

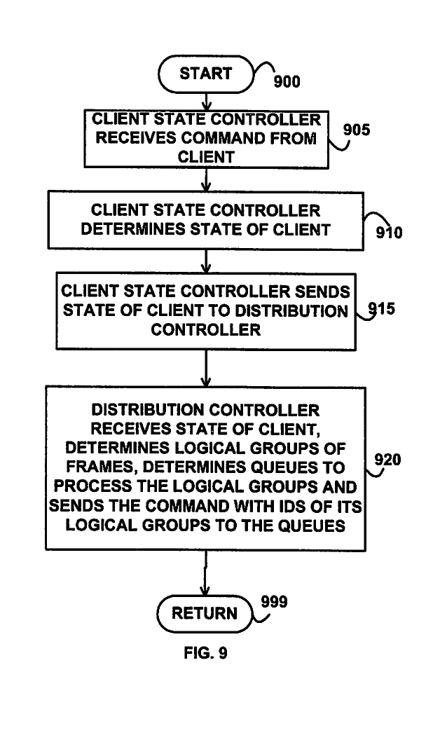

In an embodiment, the client state controller 154 and the distribution controller 156 include instructions capable of executing on the processor 101 or statements capable of being interpreted by instructions that execute on the processor 101, to carry out the functions as further described below with reference to FIGS. 9, 10, 11, and 12. In another embodiment, the client state controller 154 and/or the distribution controller 156 are implemented in hardware via logical gates and other hardware devices in lieu of, or in addition to, a processor-based system.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interconnect) bus, or any other appropriate bus technology.

The I/O interface units support communication with a variety of storage and I/O devices. For example, the terminal interface unit 111 supports the attachment of one or more user I/O devices 121, which may include user output devices (such as a video display device, speaker, and/or television set) and user input devices (such as a keyboard, mouse, keypad, touchpad, trackball, buttons, light pen, or other pointing device).

The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O device interface 113 provides an interface to any of various other input/output devices or devices of other types, such as printers or fax machines. The network interface 114 provides one or more communications paths from the computer system 100 to other digital devices (e.g., the remote disk drive 134) and the client computer systems 135 and 136; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

In various embodiments, the computer system 100 may be a multi-user “mainframe” computer system, a single-user system, or a server or similar device that has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100, the remote disk drive 134, and the client computer systems 135 and 136. In various embodiments, the network 130 may represent a storage device or a combination of storage devices, either connected directly or indirectly to the computer system 100. In an embodiment, the network 130 may support the Infiniband architecture. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The client computer systems 135 and 136 may be implemented as set-top boxes, digital video recorders (DVRs), or television sets and may include some or all of the hardware components previously described above as being included in the content server computer system 100. The client computer systems 135 and 136 are connected to the user I/O devices 121, on which the content of the programs 150 may be displayed, presented, or played.

It should be understood that FIG. 1 is intended to depict the representative major components of the server computer system 100, the network 130, the remote disk drive 134, and the client computer systems 135 and 136 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., and are referred to hereinafter as “computer programs.” The computer programs typically comprise one or more instructions that are resident at various times in various memory and storage devices in the content server computer system 100 and/or the client computer systems 135 and 136, and that, when read and executed by one or more processors in the content server computer system 100 and/or the client computer systems 135 and 136 cause the content server computer system 100 and/or the client computer systems 135 and 136 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The computer programs defining the functions of this embodiment may be delivered to the content server computer system 100 and/or the client computer systems 135 and 136 via a variety of tangible signal-bearing media that may be operatively or communicatively connected (directly or indirectly) to the processor or processors, such as the processor 101. The signal-bearing media may include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), the main memory 102, CD-RW, or diskette; or

(3) information conveyed to the server computer system 100 by a communications medium, such as through a computer or a telephone network, e.g., the network 130.

Such tangible signal-bearing media, when encoded with or carrying computer-readable and executable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying computing services (e.g., computer-readable code, hardware, and web services) that implement, some or all of the methods described herein. Aspects of these embodiments may also include analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

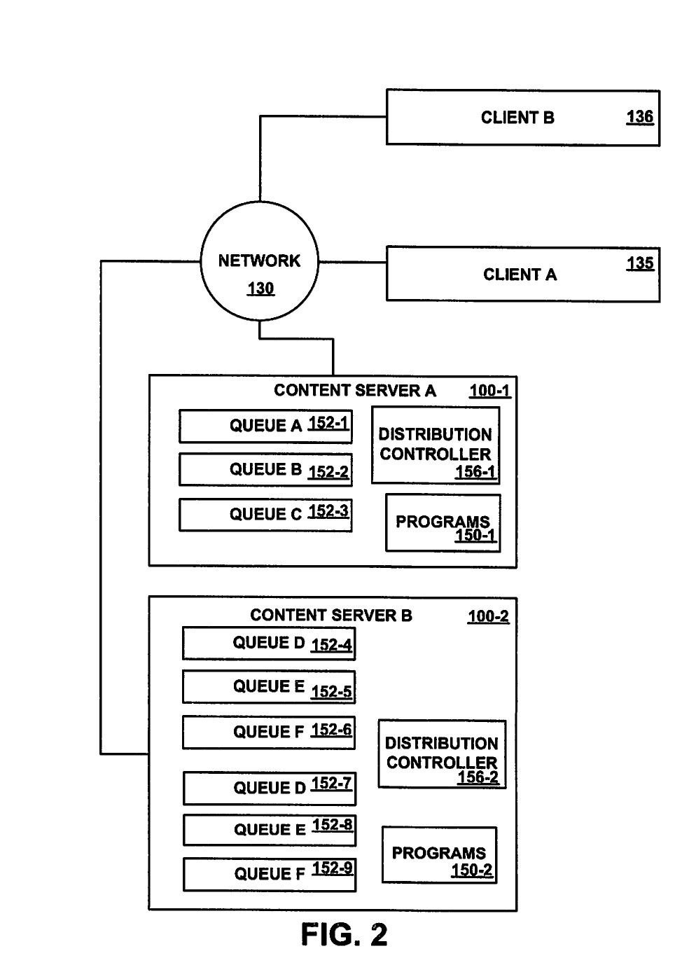

FIG. 2 depicts a high-level block diagram of selected components of the example system, according to an embodiment of the invention. The example system includes content server computer systems 100-1 and 100-2 connected to client computer systems 135 and 136 via the network 130, according to an embodiment of the present invention. The content server computer systems 100-1 and 100-1 are examples of the content server 100 (FIG. 1). Although two clients 135 and 136 and two content servers 100-1 and 100-2 are illustrated, any number of them may be present. The clients 135 and 136 may receive the same or different programs from the content servers at different times and may add content generated locally to the program content displayed via their respective I/O devices. Further, a client device may receive its program content from multiple content servers and may assemble, reorder, or inter-splice the content received from the multiple content servers into a single displayed program.

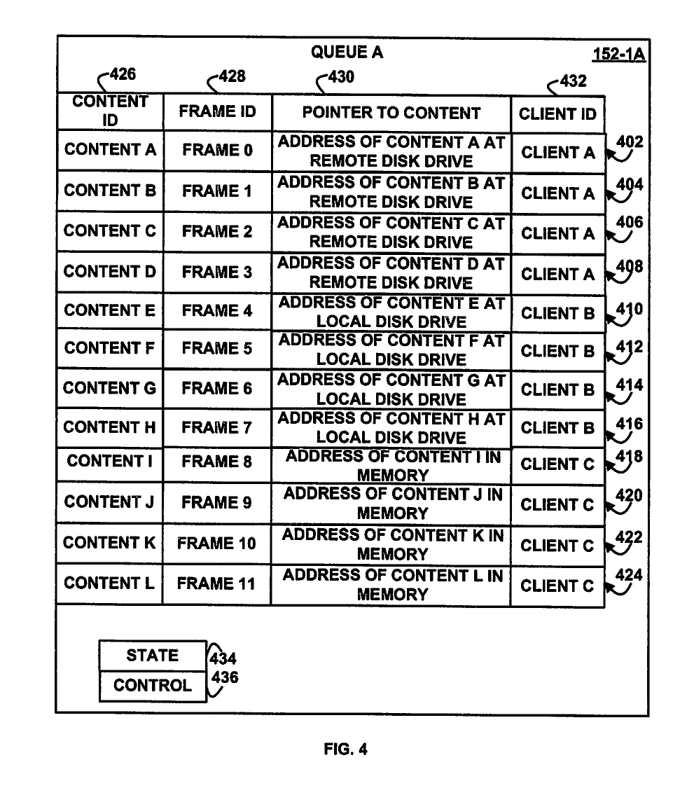

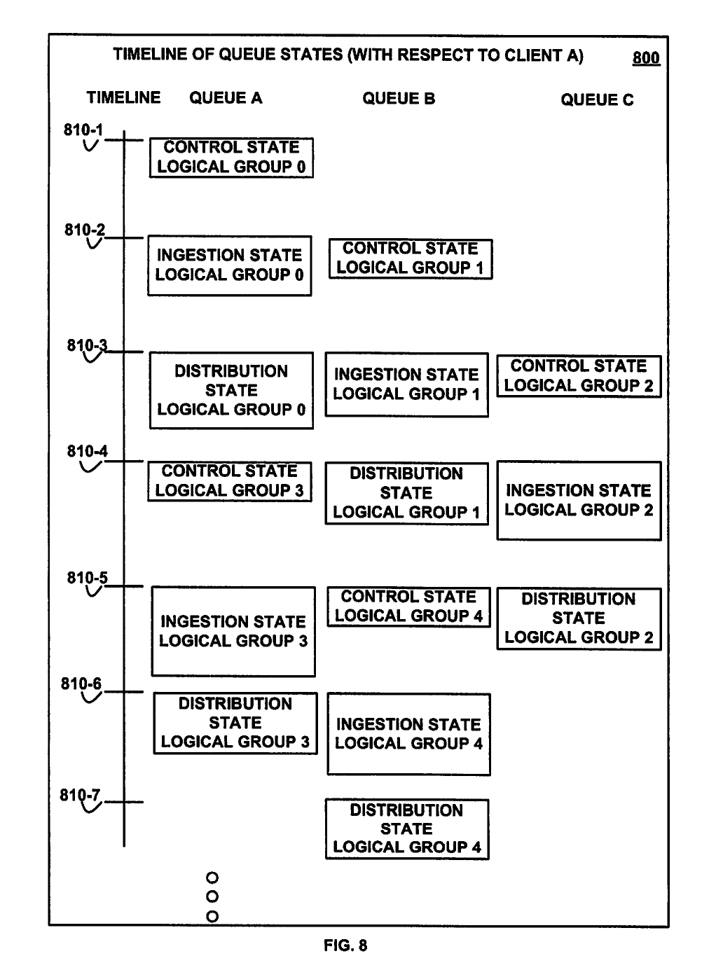

The respective content servers 100-1 and 100-2 include respective distribution controllers 156-1 and 156-2 and respective programs 150-1 and 150-2. The distribution controllers 156-1 and 156-2 are examples of the distribution controller 156 (FIG. 1). The programs 150-1 and 150-2 are examples of the programs 150 (FIG. 1). The content server 100-1 may include any number of queues (in multiples of threes), such as the queues 152-1, 152-2, and 152-3, which are examples of the queues 152 (FIG. 1). Example contents of one of the queues (the queue 152-1) while the queue is in a variety of states are further described below with reference to FIGS. 4, 5, and 6. A timeline of queue states for the queues 152-1, 152, and 152-3 is further described below with reference to FIG. 8. The content server 100-2 may include any number of queues (in multiples of three), such as the queues 152-4, 152-5, 152-6, 152-7, 152-8, and 152-9, which are examples of the queues 152 (FIG. 1).

FIG. 3 depicts a block diagram of example programs 150-1, according to an embodiment of the invention. The programs 150-1 include example frames 305-0, 305-1, 305-2, 305-3, 305-4, 305-5, 305-6, 305-7, 305-8, 305-9, 305-10, 305-11, 305-12, 305-13, 305-14, and 305-15, having respective frame numbers of frame 0, frame 1, frame 2, frame 3, frame 4, frame 5, frame 6, frame 7, frame 8, frame 9, frame 10, frame 11, frame 12, frame 13, frame 14, and frame 15, and respective content of content A, content B, content C, content D, content E, content F, content G, and content H, content I, content J, content K, content L, content M, content N, content O, and content P.

A frame represents material or data that may be presented via the user I/O device 121, at any one time. For example, if the frames include video, then a frame is a still image, and displaying the still images of the frames in succession over time (displayed in a number of frames per second), in frame number order (play order of the frames), creates the illusion to the viewer of motion or a moving picture. Frames per second (FPS) is a measure of how much information is used to store and display motion video. Frames per second applies equally to film video and digital video. The more frames per second, the smoother the motion appears. Television in the United States, for example, is based on the NTSC (National Television System Committee) format, which displays 30 interlaced frames per second while movies or films commonly display 24 frames per second.

But, in other embodiments, any number of frames per second and any appropriate format or standard for storing and presenting the programs 150-1 may be used. Embodiments of the invention may include video only, video and audio, audio only, or still images. Examples of various standards and formats in which the frames may be stored include: PAL (Phase Alternate Line), SECAM (Sequential Color and Memory), RS170, RS330, HDTV (High Definition Television), MPEG (Motion Picture Experts Group), DVI (Digital Video Interface), SDI (Serial Digital Interface), MP3, QuickTime, RealAudio, and PCM (Pulse Code Modulation).

In other embodiments, the frames represent network frames, which are blocks of data that are transmitted together across the network 130, and multiple network frames may be necessary to compose one movie or television frame. The content of the frames may include movies, television programs, educational programs, instructional programs, training programs, audio, video, advertisements, public service announcements, games, text, images, or any portion, combination, or multiple thereof. In addition to the displayable or presentable data, the frames may also include other information, such as control information, formatting information, timing information, frame numbers, sequence numbers, and identifiers of the programs and/or target clients.

The frame numbers represent the sequence or play order that the frames are to be presented or displayed via user I/O device 121, but the frames may be transmitted across the network 130 in a different order (a transmission order) and re-ordered to the displayable or playable order by the target client device 135 or 136.

The frames are organized into logical groups 310-0, 310-1, 310-2, 310-3, and 310-4. The logical group 310-0 includes frames 305-0, 305-1, 305-2, and 305-3. The logical group 310-1 includes frames 305-4, 305-5, 305-6, and 305-7. The logical group 310-2 includes frames 305-8, 305-9, 305-10, and 305-11. The logical group 310-3 includes frames 305-12, 305-13, 305-14, and 305-15. Logical groups are the units of the programs 150 that the content server 100 transmits to any one target client at any one time (during the time period or amount of time between time reference points, as further described below with reference to FIG. 8). Logical groups are also the units of the programs that the content server operates on during a state of the queue 152.

In an embodiment, the number of frames in a logical group is the display frame rate (the number of frames per second displayed at the I/O device 121 multiplied by the round trip latency of the logical group when transferred between the content server 100 and the target client. The round trip latency is the amount of time needed for the distribution controller 156 to send a logical group of frames to the target client and receive an optional acknowledgment of receipt of the logical group from the target client.

FIG. 4 depicts a block diagram of an example queue 152-1A, according to an embodiment of the invention. The queue 152-1A is an example of the queue 152-1 (FIG. 2) while the queue 152-1 is in a control state (near the end of the control state after records have been added to the queue to reflect commands received from the clients). The example queue 152-1A includes example records 402, 404, 406, 408, 410, 412, 414, 416, 418, 420, 422, and 424 each of which includes an example content identifier 426, a frame identifier 428, a pointer 430, and a client identifier 432. Each of the records in the queue 152-1A represents a frame in a logical group (e.g., the logical group 310-0, 310-1, 310-2, 310-3, or 310-4) of the program 150-1 that a client has requested to receive. Thus, the records 402, 404, 406, and 408 represent the respective frames having respective content 305-0, 305-1, 305-2, and 305-3 in the logical group 310-0; the records 410, 412, 414, and 416 represent the respective frames having the respective content 305-4, 305-5, 305-6, and 305-7 in the logical group 310-1; and the records 418, 420, 422, and 424 represent the respective frames having the respective content 305-8, 305-9, 305-10, and 305-11 in the logical group 310-2 (FIG. 3).

The content identifier 426 identifies the content that is represented by the respective record. The frame identifier 428 identifies the frame of the content. The pointer 430 includes the address of the location of the content 426. In various embodiments, the pointer 430 may point to an address in the memory 102 (as illustrated in the records 418, 420, 422, and 424), an address within secondary storage that is local to the content server 100 (as illustrated in the records 410, 412, 414, and 416), such as in the storage devices 125, 126, or 127, or may point to an address within secondary storage that is remote to the content server 100 (as illustrated in the records 402, 404, 406, and 408), e.g., the remote secondary storage 134 connected to the content server computer system 100 via the network 130. The client identifier 432 identifies the target client device (e.g., the client devices 135 or 136) that is to receive the content identified by the respective record.

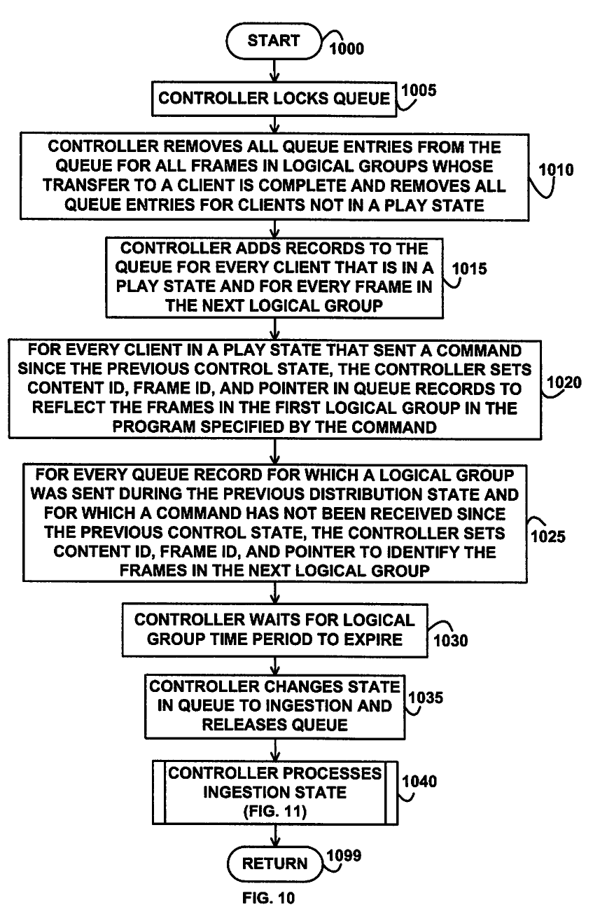

The queue 152-1A further includes a state field 434, which includes example state contents 436. The example state contents 436 identifies the control state, which is the state of the queue during which the distribution controller 156 processes control commands, such play, fast forward, rewind, pause, or skip commands and during which the distribution controller 156 adds records to the queue 152-1A that represent the content requested by the commands. The processing that the distribution controller 156 performs while the queue 152-1A is in the control state 436 is further described below with reference to FIG. 10.

As illustrated in FIG. 4, during a single control state 436, the queue 152-1A may simultaneously include different records representing different frames and different content that are intended for different client devices. For example, the records 402, 404, 406, and 408 represent frames of content in a logical group intended for the client device of “client A” while the records 410, 412, 414, and 416 represent different frames of content in a logical group intended for the client device of “client B,” and the records 418, 420, 422, and 424 represent different frames of content in a logical group intended for the client device of “client C.”

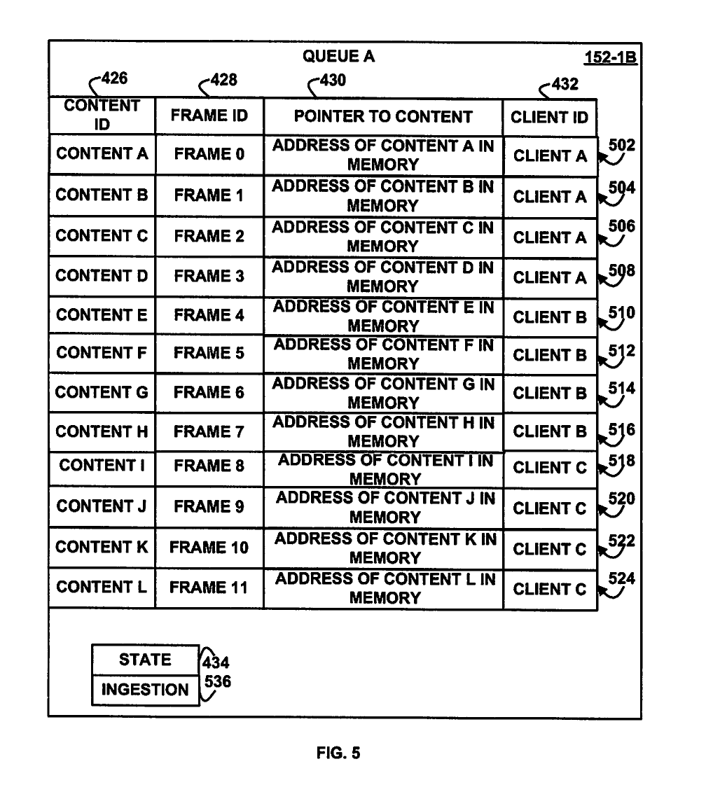

FIG. 5 depicts a block diagram of an example queue 152-1B, according to an embodiment of the invention. The queue 152-1B is an example of the queue 152-1 (FIG. 2) while the queue 152-1 is in the ingestion state. The example queue 152-1B includes example records 502, 504, 506, 508, 510, 512, 514, 516, 518, 520, 522, and 524 each of which includes an example content identifier 426, a frame identifier 428, a pointer 430, and a client identifier 432. Each of the records in the queue 152-1B represents a frame within a logical group (e.g., the logical group 310-0, 310-1, 310-2, 310-3, or 310-4) of the program 150-1 that a client has requested to receive. Thus, the records 502, 504, 506, and 508 represent the respective frames having respective content 305-0, 305-1, 305-2, and 305-3 in the logical group 310-0; the records 510, 512, 514, and 516 represent the respective frames having the respective content 305-4, 305-5, 305-6, and 305-7 in the logical group 310-1; and the records 518, 520, 522, and 524 represent the respective frames having the respective content 305-8, 305-9, 305-10, and 305-11 in the logical group 310-2 (FIG. 3).

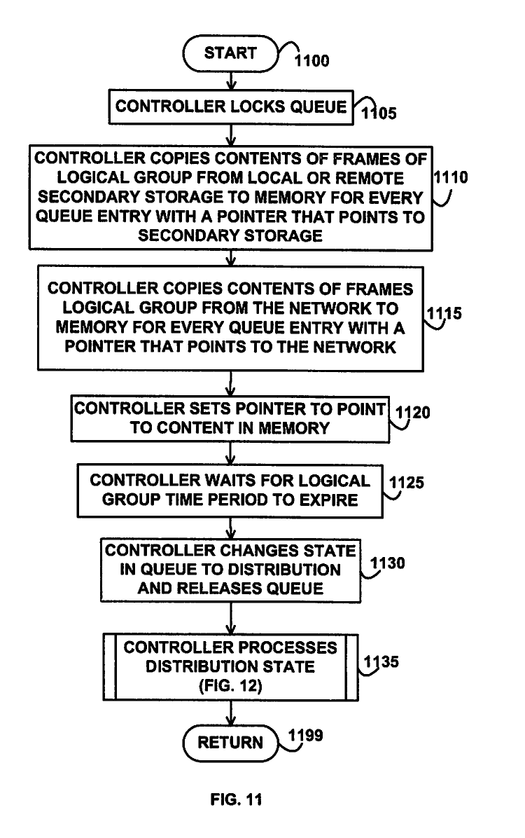

The queue 152-1B further includes a state field 434, which includes example state contents 536. The example state contents 536 identifies the ingestion state, which is the state of the queue during which the distribution controller 156 copies the content identified by the content identifier 426 into the memory 102. The processing that the distribution controller 156 performs while the queue 152-1B is in the ingestion state 536 is further described below with reference to FIG. 11.

As illustrated in FIG. 5, during a single ingestion state 536, the queue 152-1B may simultaneously include different records representing different frames and different content that are intended for different client devices. For example, the records 502, 504, 506, and 508 represent frames of content in a logical group intended for the client device of “client A” while the records 510, 512, 514, and 516 represent different frames of content in a logical group intended for the client device of “client B,” and the records 518, 520, 522, and 524 represent different frames of content in a logical group intended for the client device of “client C.”

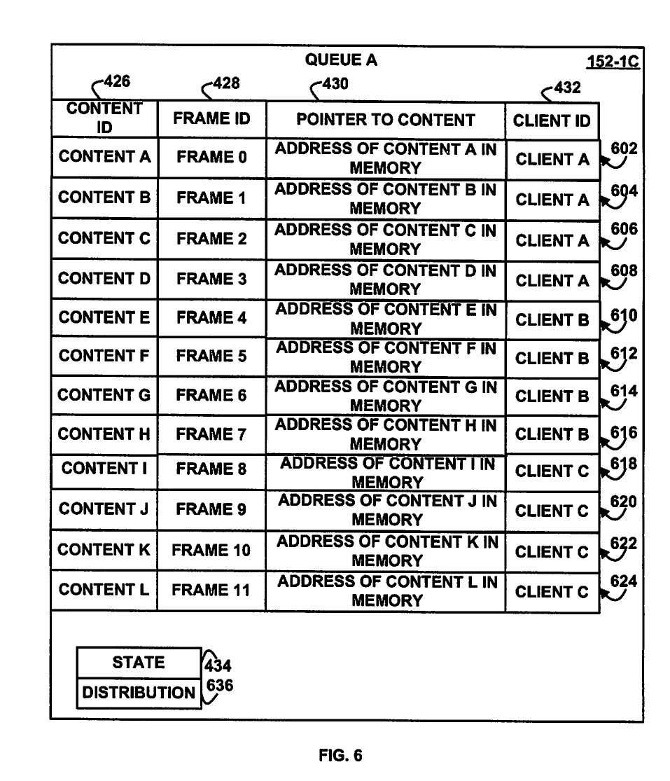

FIG. 6 depicts a block diagram of an example queue 152-1C, according to an embodiment of the invention. The queue 152-1C is an example of the queue 152-1 (FIG. 2) while the queue 152-1 is in the distribution state. The example queue 152-1C includes example records 602, 604, 606, 608, 610, 612, 614, 616, 618, 620, 622, and 624 each of which includes an example content identifier 426, a frame identifier 428, a pointer 430, and a client identifier 432. Each of the records in the queue 152-1C represents a frame in a logical group (e.g., the logical group 310-0, 310-1, 310-2, 310-3, or 310-4) of the program 150-1 that a client has requested to receive. Thus, the records 602, 604, 606, and 608 represent the respective frames having respective content 305-0, 305-1, 305-2, and 305-3 in the logical group 310-0; the records 610, 612, 614, and 616 represent the respective frames having the respective content 305-4, 305-5, 305-6, and 305-7 in the logical group 310-1; and the records 618, 620, 622, and 624 represent the respective frames having the respective content 305-8, 305-9, 305-10, and 305-11 in the logical group 310-2 (FIG. 3).

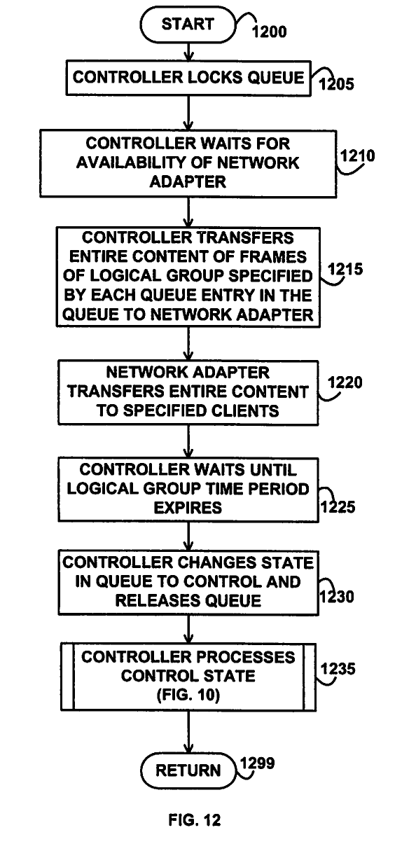

The queue 152-1C further includes a state field 434, which includes example state contents 636. The example state contents 636 identifies the distribution state, which is the state of the queue during which the distribution controller 156 sends the logical groups from the memory 102 to the client device 135 and/or 136 identified by the client identifier 432. The processing that the distribution controller 156 performs while the queue 152-1C is in the distribution state 636 is further described below with reference to FIG. 12.

As illustrated in FIG. 6, during a single distribution state 636, the queue 152-1C may simultaneously include different records representing different frames and different content that are intended for different client devices. For example, the records 602, 604, 606, and 608 represent frames of content in a logical group intended for the client device of “client A” while the records 610, 612, 614, and 616 represent different frames of content in a logical group intended for the client device of “client B,” and the records 618, 620, 622, and 624 represent different frames of content in a logical group intended for the client device of “client C.”

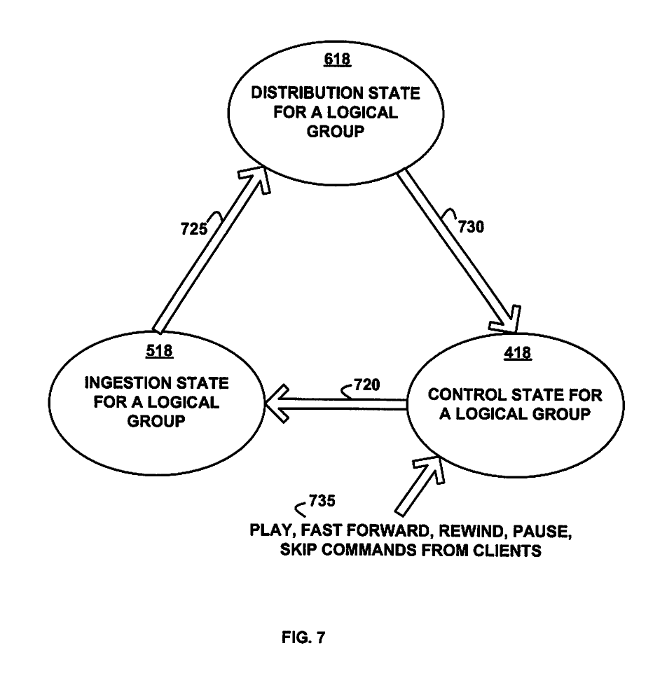

FIG. 7 depicts a block diagram of the states and state transitions of the queues, according to an embodiment of the invention. At different times, a queue 152 may be in a control state 436 (previously described above with reference to FIG. 4), an ingestion state 536 (previously described above with reference to FIG. 5), or a distribution state 636 (previously described above with reference to FIG. 6). A queue 152 stays in each of the respective states 436, 536, and 636 for a time period that is equal to the amount of time that elapses between two consecutive time reference points, as further described below with reference to FIG. 8.

While the queue 152 is in the control state 436, the distribution controller 156 processes the commands 735 received from the client. In various embodiments, the commands may be received directly or indirectly (routed from an unillustrated control server or other computer system) from the client. The distribution controller 156 then performs the state transition 720, so that the queue 152 transitions to the ingestion state 536. While the queue 152 is in the ingestion state 536, the distribution controller 156 copies program content identified by the queue records into the memory 102 (if not already present in the memory 102). The distribution controller 156 then performs the state transition 725, so that the queue 152 transitions to the distribution state 636. While the queue 152 is in the distribution state 636, the distribution controller 156 sends logical groups of program content frames (identified by the queue records) to the respective target clients. The distribution controller 156 then performs the state transition 730, so that the queue 152 transitions to the control state 436. The states and state transitions then repeat, so long as the distribution controller 156 continues to receive commands that request the transfer of program content and/or so long as more logical groups of frames remain to be transferred to clients.

The processing that the distribution controller 156 performs while the queue 152 is in the control state 436, which causes the queue 152 to perform the state transition 720 from the control state 436 to the ingestion state 536, is further described below with reference to FIG. 10. The processing that the distribution controller 156 performs while the queue 152 is in the ingestion state 536, which causes the queue 152 to perform the state transition 725 from the ingestion state 536 to the distribution state 636, is further described below with reference to FIG. 11. The processing that the distribution controller 156 performs while the queue 152 is in the distribution state 636, which causes the queue 152 to perform the state transition 730 from the distribution state 636 to the control state 436, is further described below with reference to FIG. 12.

At any one time, the queues that are within a multiple of three queues are in different states. Using the example of FIG. 2, the queues 152-1, 152-2, and 152-3 are a multiple of three queues (the multiple is one). Thus, for example, at a time period when the queue 152-1 is in the control state, the queue 152-2 is in the ingestion state, and the queue 152-3 is in the distribution state. During the next time period, the queue 152-1 is in the ingestion state, the queue 152-2 is in the distribution state, and the queue 152-3 is in the control state. During the next time period, the queue 152-1 is in the distribution state, the queue 152-2 is in the control state, and the queue 152-3 is in the ingestion state.

FIG. 8 depicts a block diagram 800 of a timeline of states of multiple queues, according to an embodiment of the invention. The timeline includes time reference points 810-1, 801-2, 810-3, 810-4, 810-5, 810-6, and 810-7, which each represents a point in time. The time reference point 810-1 is the initial time reference point, at which time the content servers begin transmission of the content to the client(s). The time reference point 810-7 is after (or is subsequent to) the time reference point 810-6, the time reference point 810-6 is after the time reference point 810-5, the time reference point 810-6 is after the time reference point 810-5, the time reference point 810-5 is after the time reference point 810-4, the time reference point 810-4 is after the time reference point 810-3, the time reference point 810-3 is after the time reference point 810-2, and the time reference point 810-2 is after the initial time reference point 810-1. The time reference points 810-1, 810-2, 810-3, 810-4, 810-5, 810-6, and 810-7 are the points in time at which the content servers begin transmission of a respective logical group of frames to the client(s), for those queues that are in a distribution state.

The time period between consecutive time reference points represents the amount of elapsed time that each of the queues 152 stays in a given state (e.g., the amount of time between the state transitions 720, 725, and 730). Logical groups are the units of the programs 150 that the content server 100 transmits to any one client during any one time period (during the time period or amount of time between time reference points). Logical groups are also the units of the programs that the content server operates on during one particular state of the queue 152. A logical group is also the unit of the content that a client device may play during one time period between two consecutive time reference points.

As illustrated in FIG. 8, between the time reference points 810-1 and 810-2, the queue A 152-1 is in the control state 436, and the distribution controller 156 processes the logical group 310-0 for the target client A 135. Between the time reference points 810-2 and 810-3, the queue A 152-1 is in the ingestion state 536, and the distribution controller 156 processes the logical group 310-0 for the target client A 135. Between the time reference points 810-3 and 810-4, the queue A 152-1 is in the distribution state 636, and the distribution controller 156 processes the logical group 310-0 for the target client A 135.

Between the time reference points 810-4 and 810-5, the queue A 152-1 is in the control state 436, and the distribution controller 156 processes the logical group 310-3 for the target client A 135. Between the time reference points 810-5 and 810-6, the queue A 152-1 is in the ingestion state 536, and the distribution controller 156 processes the logical group 310-3 for the target client A 135. Between the time reference points 810-6 and 810-7, the queue A 152-1 is in the distribution state 636, and the distribution controller 156 processes the logical group 310-3 for the target client A 135.

Between the time reference points 810-2 and 810-3, the queue B 152-2 is in the control state 436, and the distribution controller 156 processes the logical group 310-1 for the target client A 135. Between the time reference points 810-3 and 810-4, the queue B 152-2 is in the ingestion state 536, and the distribution controller 156 processes the logical group 310-1 for the target client A 135. Between the time reference points 810-4 and 810-5, the queue B 152-2 is in the distribution state 636, and the distribution controller 156 processes logical group 310-1 for the target client A 135.

Between the time reference points 810-5 and 810-6, the queue B 152-2 is in the control state 436, and the distribution controller 156 processes the logical group 310-4 for the target client A 135. Between the time reference points 810-6 and 810-7, the queue B 152-2 is in the ingestion state 536, and the distribution controller 156 processes the logical group 310-4 for the target client A 135. Starting at the time of the time reference point 810-7, the queue B 152-2 is in the distribution state 636 and processes the logical group 310-4 for the target client A 135.

Between the time reference points 810-3 and 810-4, the queue C 152-3 is in the control state 436 and processes the logical group 310-2 for the target client A 135. Between the time reference points 810-4 and 810-5, the queue C 152-3 is in the ingestion state 536 and processes the logical group 310-2 for the target client A 135. Between the time reference points 810-5 and 810-6, the queue C 152-3 is in the distribution state 636 and processes the logical group 310-2 for the target client A 135.

Thus, the target client A 135 receives the logical group 310-0 between the time reference points 810-3 and 810-4 (during the distribution state 636 of the queue A 152-1) and plays the logical group 310-1 between the time reference points 810-4 and 810-5, which is the next time period following the time period of the distribution state 636 of the queue (or later if the target client A 135 is buffering its received content). Likewise, the target client A 135 receives the logical group 310-1 between the time reference points 810-4 and 810-5 (during the distribution state 636 of the queue B 152-2) and plays the logical group 310-1 between the time reference points 810-5 and 810-6, which is the next time period following the time period of the distribution state 636 of the queue (or later). Likewise, the target client A 135 receives the logical group 310-2 between the time reference points 810-5 and 810-6 (during the distribution state 636 of the queue C 152-3) and plays the logical group 310-2 between the time reference points 810-6 and 810-7, which is the next time period following the time period of the distribution state 636 of the queue (or later). Likewise, the target client A 135 receives the logical group 310-3 between the time reference points 810-6 and 810-7 (during the distribution state 636 of the queue A 152-1) and plays the logical group 310-3 starting at the time of the time reference point 810-7, which is the start of the next time period following the time period of the distribution state 636 of the queue (or later). Thus, the client receives its program content from multiple queues during different time periods.

As illustrated in FIG. 8, during the time period between the time reference points 810-4 and 810-5, the queue A is in the control state, the queue B is in the distribution state, and the queue C is in the ingestion state. As further illustrated in FIG. 8, during the time period between the time reference points 810-5 and 810-6, the queue A is in the ingestion state, the queue B is in the control state, and the queue C is in the distribution state. As further illustrated in FIG. 8, during the time period between the time reference points 810-3 and 810-4, the queue A is in the distribution state, the queue B is in the ingestion state, and the queue C is in the control state.

FIG. 9 depicts a flowchart of example processing for handling commands from clients, according to an embodiment of the invention. Control begins at block 900. Control then continues to block 905 where the client state controller 154 receives a command from a client, directly or indirectly via another server. Control then continues to block 910 where the client state controller 154 determines the state that the client is in based on the command that the client state controller 154 most-recently received from the client. The state of the client describes whether the client is ready to receive a logical group. For example, if the most-recently received command is a play command, a skip command, a forward command, or a reverse command, then the client is in a play state, meaning that the client is ready to receive a logical group. If the most-recently received command is a pause or stop command, then the client is in a paused state, meaning that the client is not ready to receive a logical group.

Control then continues to block 915 where the client state controller 154 sends the state of the client to the distribution controller 156, including an identification of the program content requested by the client, if the command includes such an identification. The distribution controller 156 processes commands from the client when the queue 152 associated with the client reaches the control state 436, as further described below.

Control then continues to block 920 where the distribution controller 156 receives the state of the client, determines the logical groups of frames that satisfy the command, determines the queues to process the logical groups and sends the command with the identifiers of the logical groups to the queues. In an embodiment, the distribution controller may send commands for the logical groups to a single queue 152. In another embodiment, the distribution controller 156 may spread the commands for a single target client for multiple logical groups of frames across multiple queues, as previously described above with reference to FIG. 8.

Control then continues to block 999 where the logic of FIG. 9 returns.

FIG. 10 depicts a flowchart of example processing for the control state of a queue, according to an embodiment of the invention. An instance of the logic of FIG. 10 is executed for each of the queues 152. Control begins at block 1000.

Control then continues to block 1005 where the distribution controller 156 locks the queue 152, which gives this instance of the distribution controller (which is processing the control state 436 of this queue 152) exclusive access to this queue 152 and prevents other instances or threads of the distribution controller 156 from accessing this queue 152. Control then continues to block 1010 where the distribution controller 156 removes all queue records from this queue 152 that represent frames in a logical group whose transfer to its target client 432 was completed (during a previous distribution state 636) and removes all queue records from this queue 152 for those clients 432 that are in not in a play state.

Control then continues to block 1015 where, for every client that is in a play state, the distribution controller 156 adds records to this queue 152 for every frame in the respective next logical group that is to be sent to those clients. Control then continues to block 1020 where, for every client that is in a play state and that sent a command since the previous control state 436, the distribution controller 156 sets the content identifier 426, the frame identifier 428, and pointer 430 in the queue records to identify frames of the first logical group (in a play order) in the program specified by the command.

Control then continues to block 1025 where, for every queue record for which a previous logical group (previous in the play order of the program) was sent during the previous distribution state 636 of this queue 152 and for which a command has not been received since the previous control state 436, the distribution controller 156 sets the content identifier 426, the frame identifier 428, and the pointer 430 to identify the frames in the next logical group (the next logical group that is subsequent in the play order to the logical group that was sent to the client during the previous distribution state) of the program requested by the client 432 in the queue record.

Control then continues to block 1030 where the distribution controller 156 waits for the current logical group time period to expire. Control then continues to block 1035 where the distribution controller 156 changes the state 434 in the queue 152 to indicate the ingestion state 536 and releases the lock on the queue 152, which performs the state transition 720 (FIG. 7).

Control then continues to block 1040 where the distribution controller 156 processes the ingestion state 536, as further described below with reference to FIG. 11. Control then continues to block 1099 where the logic of FIG. 10 returns.

FIG. 11 depicts a flowchart of example processing for the ingestion state of a queue, according to an embodiment of the invention. An instance of the logic of FIG. 11 is executed for each of the queues 152. Control begins at block 1100.

Control then continues to block 1105 where the distribution controller 156 locks the queue 152, which gives the distribution controller 156 exclusive access to the queue 152 and prevents other programs, processes, or threads from accessing the queue 152. Control then continues to block 1110 where, for every queue record with a pointer 430 that points to secondary storage (remote or local), the distribution controller 156 copies the contents of the frame (the pointer 430 points at the frame content) from local secondary storage (e.g., a local disk drive 125, 126, or 127) or from remote secondary storage (e.g., the remote disk drive 134 attached to the content server 100 via the network 130) to the memory 102.

Control then continues to block 1115 where, for every queue record with a pointer 430 that points to a network address, the distribution controller 156 copies the contents of the frame from the network (e.g., computer systems within the network) to the memory 102. Control then continues to block 1120 where the distribution controller 156 sets the pointer 430 in the queue records to point to (to contain the address of) the content in the memory 102.

Control then continues to block 1125 where the distribution controller 156 waits for the logical group time period to expire. Control then continues to block 1130 where the distribution controller 156 changes the state in the queue 152 to indicate the distribution state 636 and releases the lock on the queue 152, which performs the state transition 725. Control then continues to block 1135 where the distribution controller 156 processes the distribution state 636 of the queue 152, as further described below with reference to FIG. 12.

Control then continues to block 1199 where the logic of FIG. 11 returns.

FIG. 12 depicts a flowchart of example processing for the distribution state of the queue, according to an embodiment of the invention. An instance of the logic of FIG. 12 is executed for each of the queues 152.

Control begins at block 1200. Control then continues to block 1205 where the distribution controller 156 locks the queue 152. Control then continues to block 1210 where the distribution controller 156 waits for the availability of the network adapter 114. Control then continues to block 1215 where the distribution controller 156 transfers the entire contents of the frame specified by each queue record in the queue 152 to the network adapter 114. Control then continues to block 1220 where the network adapter 114 transfers the contents of the frame specified by each queue record from the memory 102 to the target clients specified by each queue record, which results in transferring all of the frames in the respective logical groups to the respective clients during one logical group time period. Control then continues to block 1225 where the distribution controller 156 waits until the logical group time period expires. Control then continues to block 1230 where the distribution controller 156 changes the state of the queue 152 to the control state 436 and releases the lock on the queue 152, which performs the state transition 730. Control then continues to block 1235 where the distribution controller 156 processes the control state 436, as previously described above with reference to FIG. 10. Control then continues to block 1299 where the logic of FIG. 12 returns.

Thus, by cycling through the states 436, 536, and 636 at the time reference points 810-1, 810-2, 810-3, 810-4, 810-5, 810-6, and 810-7, an embodiment of the invention transmits the frame content in logical groups, which eliminates the need for complex session handling between the clients 135 and 136 and the server 100. Further, the transmission of logical groups of frame content within logical group time periods provides predictable network bandwidth consumption, such that an embodiment of the invention drives the network load higher than does conventional asynchronous IP network traffic.

The previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

What is claimed is:

1. A method comprising:
distributing a first plurality of records to a first queue, a second queue, and a third queue during a respective control state of the first queue, the second queue, and the third queue, wherein the each of the first plurality of records represents a respective frame in a respective logical group;
copying the frames of the logical group that are represented by the first plurality of records to memory during a respective ingestion state of the first queue, the second queue, and the third queue; and
transferring the frames of the logical group that are represented by the first plurality of records from the memory to a first client device during a respective distribution state of the first queue, the second queue, and the third queue, wherein each of the control state, the ingestion state, and the distribution state last for time durations equal to a time period necessary to play the logical group at the first client device.

2. The method of claim 1, wherein the first queue is in the control state during a first time period that the second queue is in the distribution state and that the third queue is in the ingestion state.

3. The method of claim 2, wherein the first queue is in the ingestion state during a second time period that the second queue is in the control state and that the third queue is in the distribution state.

4. The method of claim 3, wherein the first queue is in the distribution state during a third time period that the second queue is in the ingestion state and that the third queue is in the control state.

5. The method of claim 1, further comprising:
performing state transitions between the control state, the ingestion state, and the distribution state at time reference points between the time durations.

6. The method of claim 1, further comprising:
performing the distributing, the copying, and the transferring for a second plurality of records and a second client device, wherein the second plurality of records exist simultaneously with the first plurality of records in the first queue, the second queue, and the third queue.

7. The method of claim 1, wherein the distributing further comprises:
distributing the first plurality of records that represent the logical group that is a next logical group in a play order.

8. A method for deploying computing services, comprising:
integrating computer readable code into a computer system, wherein the code in combination with the computer system performs the method of claim 1.

9. A storage medium encoded with instructions, wherein the instructions when executed on a processor comprise:
distributing a first plurality of records to a first queue, a second queue, and a third queue during a respective control state of the first queue, the second queue, and the third queue, wherein the each of the first plurality of records represents a respective frame in a respective logical group;
copying the frames of the logical group that are represented by the first plurality of records to memory during a respective ingestion state of the first queue, the second queue, and the third queue; and
transferring the frames of the logical group that are represented by the first plurality of records from the memory to a first client device during a respective distribution state of the first queue, the second queue, and the third queue, wherein each of the control state, the ingestion state, and the distribution state last for time durations equal to a time period necessary to play the logical group at the first client device, wherein the first queue is in the control state during a first time period that the second queue is in the distribution state and that the third queue is in the ingestion state.

10. The storage medium of claim 9, wherein the first queue is in the ingestion state during a second time period that the second queue is in the control state and that the third queue is in the distribution state.

11. The storage medium of claim 10, wherein the first queue is in the distribution state during a third time period that the second queue is in the ingestion state and that the third queue is in the control state.

12. The storage medium of claim 9, further comprising:
performing state transitions between the control state, the ingestion state, and the distribution state at time reference points between the time durations.

13. The storage medium of claim 9, further comprising:
performing the distributing, the copying, and the transferring for a second plurality of records and a second client device, wherein the second plurality of records exist simultaneously with the first plurality of records in the first queue, the second queue, and the third queue.

14. The storage medium of claim 9, wherein the distributing further comprises:
distributing the first plurality of records that represent the logical group that is a next logical group in a play order.

15. A computer system comprising:
a processor; and
memory connected to the processor, wherein the memory encodes instructions that when executed by the processor comprise:
distributing a first plurality of records to a first queue, a second queue, and a third queue during a respective control state of the first queue, the second queue, and the third queue, wherein the each of the first plurality of records represents a respective frame in a respective logical group,
copying the frames of the logical group that are represented by the first plurality of records to memory during a respective ingestion state of the first queue, the second queue, and the third queue, and
transferring the frames of the logical group that are represented by the first plurality of records from the memory to a first client device during a respective distribution state of the first queue, the second queue, and the third queue, wherein each of the control state, the ingestion state, and the distribution state last for time durations equal to a time period necessary to play the logical group at the first client device, wherein the first queue is in the control state during a first time period that the second queue is in the distribution state and that the third queue is in the ingestion state.

16. The computer system of claim 15, wherein the first queue is in the ingestion state during a second time period that the second queue is in the control state and that the third queue is in the distribution state.

17. The computer system of claim 16, wherein the first queue is in the distribution state during a third time period that the second queue is in the ingestion state and that the third queue is in the control state.

18. The computer system of claim 15, wherein the instructions further comprise:
performing state transitions between the control state, the ingestion state, and the distribution state at time reference points between the time durations.

19. The computer system of claim 15, wherein the instructions further comprise:
performing the distributing, the copying, and the transferring for a second plurality of records and a second client device, wherein the second plurality of records exist simultaneously with the first plurality of records in the first queue, the second queue, and the third queue.

20. The computer system of claim 15, wherein the distributing further comprises:
distributing the first plurality of records that represent the logical group that is a next logical group in a play order.
